(19) United States
(12) Patent Application Publication
(10) Pub. No.: US 2017/0292090 A1
(43) Pub. Date: Oct. 12, 2017

(54) POUCHED, WATER DISPERSIBLE DETERGENT FORMULATIONS WITH HIGH WATER CONTENT

(71) Applicants: Rohm and Haas Company, Philadelphia, PA (US); Dow Global Technologies LLC, Midland, MI (US)

(72) Inventors: Afua Sarpong KARIKARI, Bristol, PA (US); Vikram PRASAD, Midland, MI (US); Sarah J. VIETZKE, Midland, MI (US)

(21) Appl. No.: 15/516,924

(22) PCT Filed: Oct. 9, 2015
(86) PCT No.: PCT/US2015/054829

§ 371 Date: Apr. 5, 2017

Related U.S. Application Data
(60) Provisional application No. 62/062,991, filed on Oct. 13, 2014.

(51) Int. Cl. C11D 3/37; C11D 3/10; C11D 3/08; C11D 17/04; C11D 3/04

(52) U.S. Cl. CPC C11D 3/3765; C11D 17/043; C11D 3/046; C11D 3/08; C11D 3/10

(57) ABSTRACT

A detergent contained in a sealed package. The liquid detergent comprises: (a) from 14 to 40 wt % surfactants, (b) from 3 to 25 wt % salts, and (c) from 40 to 75 wt % water. The package is made from an ethylene-(meth)acrylic acid copolymer which is in direct contact with the liquid detergent. The copolymer comprises from 70 to 90 wt % polymerized units of ethylene, from 10 to 30 polymerized units of (meth)acrylic acid and no more than 0.2 wt % crosslinker.

This invention relates to detergent formulations enclosed in water-dispersible pouches.

Pouched detergent formulations are known, as in, e.g., US20060281658, which describes a high-salt formulation in a polyvinyl alcohol pouch. However, this reference does not suggest the use of the pouched detergent formulations claimed herein.

The problem solved by this invention is the need for improved pouched cleaning detergent formulations with high water content.

### STATEMENT OF INVENTION

The present invention provides a detergent contained in a sealed package, said detergent comprising: (a) from 14 to 40 wt % surfactants, (b) from 3 to 25 wt % salts, and (c) from 40 to 75 wt % water; wherein said package comprises an ethylene-(meth)acrylic acid copolymer in direct contact with the detergent, said copolymer comprising from 70 to 90 wt % polymerized units of ethylene, from 10 to 30 polymerized units of (meth)acrylic acid and no more than 0.2 wt % crosslinker.

### DETAILED DESCRIPTION

Percentages are weight percentages (wt %) and temperatures are in ° C., unless specified otherwise. Operations were performed at room temperature (20-25° C.), unless specified otherwise. Weight percentages of components in detergent are based on weights of active ingredients, e.g., surfactant molecules without any water that may be in a commercial surfactant product, and on the weight of the entire liquid laundry detergent composition, including water. Percentages of ethylene, (meth)acrylic acid or crosslinker units in the copolymer are based on total weight of the polymer chains. The term “(meth)acrylic” means methacrylic or acrylic.

Preferably, the detergent is a cleaning formulation or a laundry detergent, preferably a laundry detergent. Preferably, the sealed package containing the detergent is added to a washing machine.

Preferably, the ethylene-(meth)acrylic acid copolymer comprises at least 73 wt % ethylene, preferably at least 76 wt %, preferably at least 78 wt %; preferably no more than 87 wt %, preferably no more than 84 wt %, preferably no more than 82 wt %. Preferably, the ethylene-(meth)acrylic acid copolymer comprises at least 13 wt % (meth)acrylic acid, preferably at least 16 wt %, preferably at least 18 wt %; preferably no more than 27 wt %, preferably no more than 24 wt %, preferably no more than 22 wt %. Preferably, the ethylene-(meth)acrylic acid copolymer is a random copolymer. Preferably, the ethylene-(meth)acrylic acid copolymer is an ethylene-acrylic acid copolymer.

Preferably, the number-average molecular weight (Mn) of the ethylene-(meth)acrylic acid copolymer is from 2,000 to 20,000; preferably from 2,500 to 15,000; preferably from 3,000 to 10,000. Preferably, the weight-average molecular weight (Mw) of the ethylene-(meth)acrylic acid copolymer is from 8,000 to 150,000; preferably from 10,000 to 100,000; preferably from 12,000 to 60,000; preferably from 14,000 to 30,000. Preferably, the ethylene-(meth)acrylic acid copolymer is partially neutralized, i.e., from 50 to 100 mole % of the carboxylic acid groups is neutralized by addition of a base, preferably at least 70%, preferably at least 80%, preferably at least 85%, preferably at least 88%; preferably no more than 96%, preferably no more than 94%, preferably no more than 92 wt %. Preferably, the base is an alkali metal hydroxide, preferably sodium or potassium hydroxide, preferably potassium hydroxide.

Preferably, the amount of crosslinker in the ethylene-(meth)acrylic acid copolymer is no greater than 0.15 wt %, preferably no greater than 0.1 wt %, preferably no greater than 0.05 wt %, preferably no greater than 0.02 wt %; all percentages based on dry polymer. A crosslinker is a polymerized unit of a multiethylenically unsaturated monomer or a metal ion selected from the group consisting of Zn⁺², Ca⁺², Mg⁺² and Al⁺³. Percentages of metal ions are based on metal alone, without the anion.

Preferably, the detergent comprises at least 17 wt % surfactants, preferably at least 20 wt %, preferably at least 23 wt %, preferably at least 26 wt %; preferably no more than 38 wt %, preferably no more than 35 wt %, preferably no more than 32 wt %. Preferably, the detergent comprises at least 43 wt % water, preferably at least 46 wt %, preferably at least 49 wt %, preferably at least 52 wt %, preferably at least 55 wt %; preferably no more than 72 wt %, preferably no more than 69 wt %, preferably no more than 66 wt %.

Preferably, the detergent composition comprises at least 4 wt % of salts; preferably at least 5 wt %, preferably at least 7 wt %, preferably at least 9 wt %; preferably no more than 20 wt %, preferably no more than 17 wt %, preferably no more than 15 wt %, preferably no more than 13 wt %. The amount of salts does not include any anionic or cationic surfactants present in the detergent. Preferably, salts have no more than ten carbon atoms, preferably no more than six carbon atoms, preferably no more than three carbon atoms. Preferably, salts are selected from the group consisting of chlorides, citrates, phosphates, sulfates, carbonates, metasilicates and aluminosilicates. Preferably, the cations of the salts are alkali metal ions or ammonium ions. Preferably, the detergent comprises a salt which is selected from the group consisting of sodium chloride, ammonium chloride and ammonium sulfate; preferably sodium chloride or ammonium chloride.

The surfactant(s) may be cationic, anionic, nonionic, fatty acid metal salt, zwitterionic or betaine surfactants. Preferably, the formulation comprises at least one anionic surfactant, preferably at least two. Preferably, nonionic surfactants have an alkyl group having at least eight carbon atoms and at least five polymerized ethylene oxide or propylene oxide residues. Preferably, nonionic surfactants have at least five polymerized ethylene oxide residues, preferably at least six, preferably at least seven,; preferably no more than twelve, preferably no more than eleven, preferably no more than ten. Preferably, the detergent composition comprises at least 5 wt % linear alcohol ethoxylates, preferably at least 6 wt %, preferably at least 8 wt %; preferably no more than 15 wt %, preferably no more than 13 wt %, preferably no more than 11 wt %. Preferably, a linear alcohol ethoxylate has a C₈-C₁₈ alkyl group, preferably C₁₀-C₁₆, preferably C₁₂-C₁₅. Preferably, a linear alcohol ethoxylate contains from six to twelve polymerized units of ethylene oxide, preferably from seven to ten. Preferably, anionic surfactants have an alkyl group having at least ten carbon atoms and an anionic group, preferably selected from sulfonates and sulfates. Anionic surfactants also may have polymerized residues of ethylene oxide, and/or may have aromatic rings, e.g., linear alkylbenzene sulfonates. Some anionic surfactants are fatty acid alkali metal salts. Preferably, the detergent composition comprises no more than 5 wt % linear alkylbenzene sulfonates, preferably no more than 3 wt %, preferably no more than 1 wt %. Preferably, alkylbenzene sulfonates have a C₁₀-C₁₄ alkyl group. Preferably, the detergent composition comprises at least 2 wt % alkyl sulfates, preferably at least 3 wt %, preferably at least 4 wt %. Preferably, the detergent composition comprises no more than 12 wt % alkyl sulfates, preferably no more than 10 wt %, preferably no more than 8 wt %. Preferably, an alkyl sulfate contains from one to five polymerized ethylene oxide units per molecule. Preferably, the detergent composition comprises at least 10 wt % linear alkyl sulfonate, preferably at least 13%, preferably at least 16%. Preferably, the composition comprises no more than 25 wt % linear alkyl sulfonates, preferably no more than 22 wt %.

Preferably, the pH of the detergent composition is from 4 to 11, preferably from 4.5 to 10, preferably from 4.5 to 9. Suitable bases to adjust the pH of the formulation include mineral bases such as sodium hydroxide and potassium hydroxide; ammonium hydroxide; and organic bases such as mono-, di- or tri-ethanolamine; or 2-dimethylamino-2-methyl-1-propanol (DMAMP). Mixtures of bases may be used. Suitable acids to adjust the pH of the aqueous medium include mineral acid such as hydrochloric acid, phosphorus acid, and sulfuric acid; and organic acids such as acetic acid. Mixtures of acids may be used. The formulation may be adjusted to a higher pH with base and then back titrated to the ranges described above with acid.

### EXAMPLES

Preparation of ethylene/acrylic acid (92% KOH neutralized) films: On a glass, polypropylene terephthalate (PPT), or biaxially-oriented polyethylene (BOPET) substrate, place a draw-down bar that has a 15 mil (375 μm) edge in perpendicular to the direction the film is to be drawn. Add a dispersion of a copolymer (80/20 ethylene-acrylic acid, between 85 and 92% neutralization, Mn ca. 5000) in the area enclosed by the draw-down bar. Slowly drag the draw-down bar from one end of the substrate to the other, pulling the dispersion so a uniform layer is created. Place substrate within a forced-air oven set at 40° C., for 20 minutes. After this step, gently peel off one edge of the film that is created with the aid of a blade, then proceed to peel the rest of the film by hand. This process should create films that are ˜3 mils (˜75 μm) thick.

Preparation of formulations: Combine the surfactants and vortex into a slurry using a FlackTek SPEEDMIXER (Model DAC 150 FVZ-K) at 3540 rpm for 1 minute. Add any solvents and water to the slurry and repeat mixing. Then, add any hydrotropes, builders, and salts and mix for 3 minutes at 3540 rpm. Allow the formulation to equilibrate overnight or turn into a clear, single-phase liquid before using. All the detergent formulations are homogeneous, clear and transparent liquids that are stable for extended periods of time.

Preparation of pouches: Cut 2″×4″ strip of from the film prepared as described above. Fold midway along longest edge to obtain 2″×2″ pouch surface doubled over. With the help of an 8″ MIDWEST PACIFIC heat sealer and using a heat setting of “3,” seal each of the two edges parallel to each other for ˜3 seconds, creating a pouch with one open edge. Using a transfer pipette, insert ˜2-3 mL of formulation within the pouch. Finally, seal the open edge of the pouch with the impulse sealer. Place the pouch within a lint-free wipe-lined, petri dish for stability observation.

Pouch Preparation with PVOH

Polyvinyl alcohol (PVOH) (Product M8630) films are obtained from MonoSol®; therefore, no preparation is required. Cut strips from pre-made films and follow same procedure as used for ethylene/acrylic acid films.

| | | | Rating | Rating | |
|---|---|---|---|---|---|
| | | | of | of | |
| | | Plasticizer/ | EAA | PVOH | Com- |
| Form. | Salt (wt %) | Solvent (wt %) | pouches | pouches | ments |
| A | — | — | Poor | Fair | |
| B | — | — | Fair | Fair | |
| C | — | — | Fair | Fair | |
| C | 5% NaCl | — | Poor | Poor | |
| C | 10% NaCl | — | Fair/Good | Poor | |
| C | 10% NaCl | 4% PG | Poor | Poor | |
| C | 10% NaCl | 2% PG | Fair | Poor | |
| C | ~10% NaCl | MEA to pH ~11 | Poor | Poor | |
| C | 10% NaCl | NaOH (5M) | Poor | N/A | |
| | | to pH 8.1 | | | |
| C | 5% KCl | — | Poor | Poor | |
| C | 10% KCl | — | — | — | U |
| C | 5% CaCl₂ | — | — | — | U |
| C | 10% CaCl₂ | — | — | — | U |
| C | 5% NH₄Cl | | Very good | Poor | |
| C | 10% NH₄Cl | — | Very good | Fair | |
| C | 5% NH₄Cl | NaOH (5M) to pH 7 | Fair | Poor | |
| C | 10%NH₄Cl | NaOH (5M) | Fair | Poor | |
| | | to pH 7.7 | | | |
| C | 5% Na₂CO₃ | — | Fair | Fair | |
| C | 10% Na₂CO₃ | — | — | — | U |
| C | 5% K₂CO₃ | — | Poor | Poor | |
| C | 10% K₂CO₃ | — | — | — | U |
| C | 5% CaCO₃ | — | — | — | U |
| C | 5% Na₂SO₄ | — | Poor | Poor | |
| C | 10% Na₂SO₄ | — | Poor | Poor | |
| C | 10% Na₂SO₄ | 4% PG | — | — | U |
| C | 5% (NH₄)₂SO₄ | — | Good | Fair | |
| C | 5% (NH₄)₂SO₄ | NaOH (5M) | Fair | N/A | |
| | | to pH 6.9 | | | |
| C | 10% (NH₄)₂SO₄ | — | — | — | U |
| C | 10% (NH₄)₂SO₄ | 4% PG | — | — | U |
| C | 5% NaCit | — | Poor | Poor | |
| C | 10% NaCit | — | Poor | Poor | |
| C | 10% NaCit | 2% PG | Poor | Poor | |
| C | 10% NaCit | 4% PG | Poor | Poor | |
| C | 5% Na₂SiO₃ | — | Fair | Fair | |
| C | 10% Na₂SiO₃ | — | — | — | U |

Rating system: “Poor”=stable for 0-1 day; “fair”=stable for 1-5 days, “good”=stable for 5-14 days, “Very good”=stable for upwards of 14 days Formulation A contained 20% ALPHA-STEP PC-48 (sodium methyl 2-sulfolaurate) in addition to the indicated salt and plasticizer/solvent. Formulation B contained 19.5% ALPHA-STEP PC-48 and 10% BIO-SOFT N25-7 (alcohol ethoxylate) in addition to the indicated salt and plasticizer/solvent. Formulation C contained 19.5% ALPHA-STEP PC-48, 9.5% BIO-SOFT N25-7, and 6.5% STEOL CS-270 (alcohol ethoxylate sulfate) in addition to the indicated salt and plasticizer/solvent. The remainder of all formulations was water. “U” indicates that the formulation was unstable and therefore was not tested in pouches. “NaCit” is sodium citrate. “EAA” is ethylene/acrylic acid copolymer. “PG” is propylene glycol

The results presented in the table demonstrate that, for the tested formulations, of the various sodium, potassium and ammonium salts with chloride, carbonate, sulfate, citrate and silicate anions, only sodium chloride, ammonium chloride and ammonium sulfate resulted in pouched formulations having superior stability relative to PVOH based pouches.

1. A detergent contained in a sealed package, said detergent comprising: (a) from 14 to 40 wt % surfactants, (b) from 3 to 25 wt % salts, and (c) from 40 to 75 wt % water; wherein said package comprises an ethylene-(meth)acrylic acid copolymer in direct contact with the liquid detergent, said copolymer comprising from 70 to 90 wt % polymerized units of ethylene, from 10 to 30 polymerized units of (meth)acrylic acid and no more than 0.2 wt % crosslinker.

2. The detergent of claim 1 in which the salts are selected from the group consisting of chlorides, citrates, phosphates, sulfates carbonates, metasilicates and aluminosilicates.

3. The detergent of claim 2 in which the copolymer has no more than 0.05 wt % crosslinker.

4. The detergent of claim 3 comprising from 4 to 15 wt % salts.

5. The detergent of claim 4 comprising from 46 to 72 wt % water.

6. The detergent of claim 5 comprising from 17 to 38 wt % surfactants.

7. The detergent of claim 6 in which the copolymer comprises from 76 to 84 wt % polymerized units of ethylene and from 16 to 24 polymerized units of (meth)acrylic acid.

8. The detergent of claim 6 in which the copolymer comprises ethylene and acrylic acid.

9. The detergent of claim 8 in which the salts are selected from the group consisting of sodium chloride, ammonium chloride and ammonium sulfate.
